(19) United States
(12) Patent Application Publication
(10) Pub. No.: US 2016/0179161 A1
(43) Pub. Date: Jun. 23, 2016

(54) DECODE INFORMATION LIBRARY

(71) Applicants: Robert P. Adler, Santa Clara, CA (US); Satish Venkatesan, San Jose, CA (US); Timothy J. Jennings, Chandler, AZ (US)

(72) Inventors: Robert P. Adler, Santa Clara, CA (US); Satish Venkatesan, San Jose, CA (US); Timothy J. Jennings, Chandler, AZ (US)

(21) Appl. No.: 14/579,565

(22) Filed: Dec. 22, 2014

(51) Int. Cl. G06F 1/32

(52) U.S. Cl. CPC G06F 1/32

(57) ABSTRACT

For each of a plurality of ports to be defined for an interconnect fabric, a respective computing block is identified to be connected to the port. One or more entries in a library of decode information is identified for each of the identified computing blocks. An intermediate representation of a fabric of the system on chip is generated based on the identified entries in the library of decode information.

### FIELD

This disclosure pertains to computing system, and in particular (but not exclusively) to system design tools.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (i.e. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates a simplified block diagram representing an example system.

FIG. 6 illustrates a simplified block diagram representing an example system including an example decode information library.

FIG. 7 illustrates a representation of mapping decode information library entries to ports of a fabric.

FIGS. 8A-8L are screenshots of example graphical user interfaces of tools for use in connection with a library of decode information.

FIG. 9 illustrates an embodiment of a block diagram for a computing system including a multicore processor.

FIG. 10 illustrates another embodiment of a block diagram for a computing system.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate to software optimizations for energy conservation and efficiency. As will become readily apparent in the description below, the embodiments of methods, apparatus′, and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

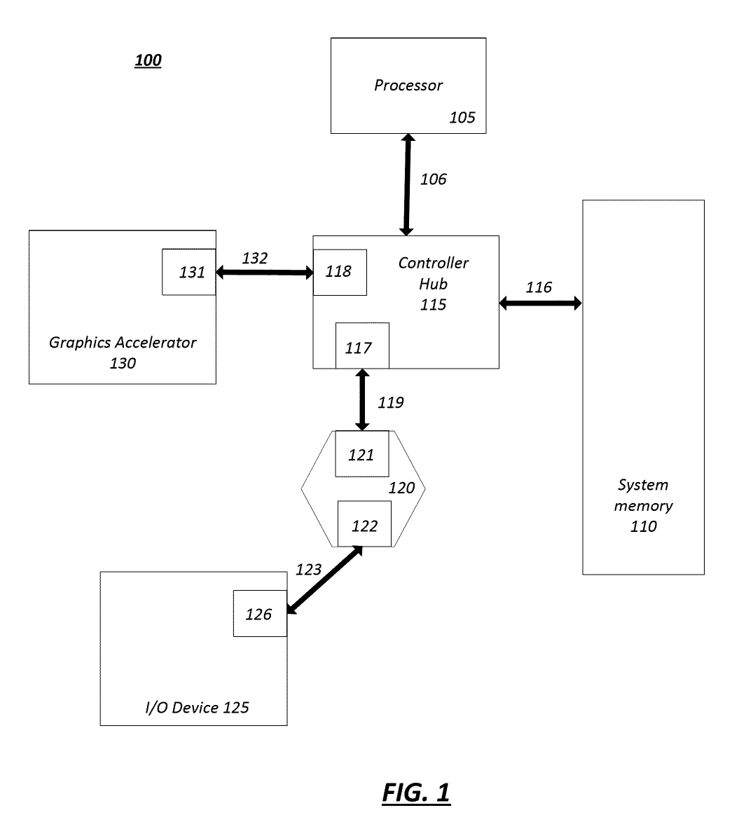

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105.

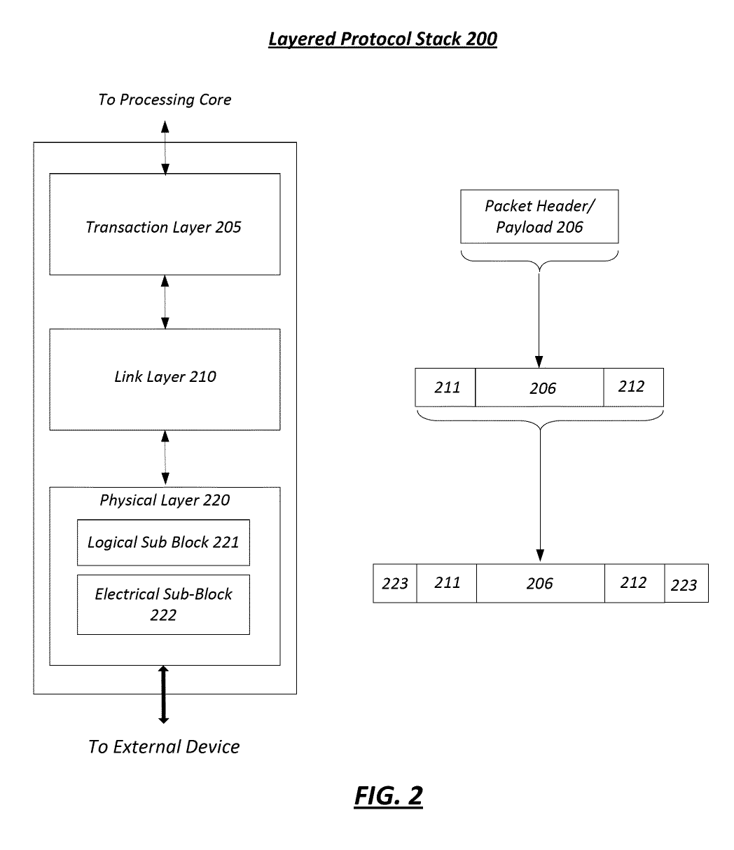

Turning to FIG. 2 an embodiment of a layered protocol stack is illustrated. Layered protocol stack 200 includes any form of a layered communication stack, such as a Quick Path Interconnect (QPI) stack, a PCie stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 205 assembles packet header/payload 206. Format for current packet headers/payloads may be found in the PCIe specification at the PCIe specification website.

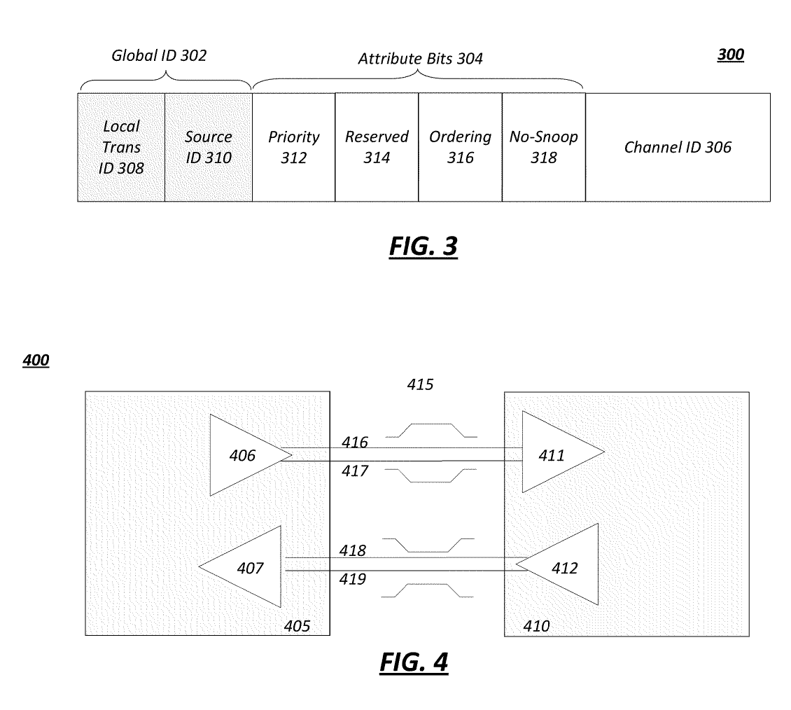

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/411 and a receive pair 412/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

Traditional interconnect architectures, including PCI and PCIe were developed and standardized largely around the paradigm of traditional computing devices, such as personal computers (PCs), where chip-to-chip connections, plug and play, and componentized architectures were the norm. Newer technologies have emphasized smaller, more mobile computing, with smart phones, netbooks, laptops, and tablets complimenting desktop computers within the marketplace. Given the decreasing size and compact form factors of mobile computing devices, personal computers have become less modular. Where in the past it was relatively common to replace graphics cards, memory, and other components, accessing or upgrading the components of a smart phone, tablet, or other such device is uncommon. Indeed, in some markets, the expectation is that when an upgrade is needed, the owner trades-in or otherwise replaces a previous device with an entirely new device, where in years past, the owner may have tried to extend the lifespan of the device by upgrading individual components. In many modern systems, computing hardware is migrating from a modular model to an integrated one, with multiple components being integrated on a single board, or a system on chip (SoC).

Some believe that the trend toward integration is likely to make traditional I/O technologies obsolete, including existing interconnect architectures, as the purpose of I/O technology development shifts from enabling chip-to-chip connections towards enabling SoC intellectual property (IP) block (or “computing block”) integration. An IP block can refer to a reusable unit of logic, circuitry, or chip layout. An SoC can include multiple IP blocks, including multiple instances of the same IP block. An IP block, in some instances, can support multiple functions, facilitated, in some cases, by one or multiple devices included in the IP block.

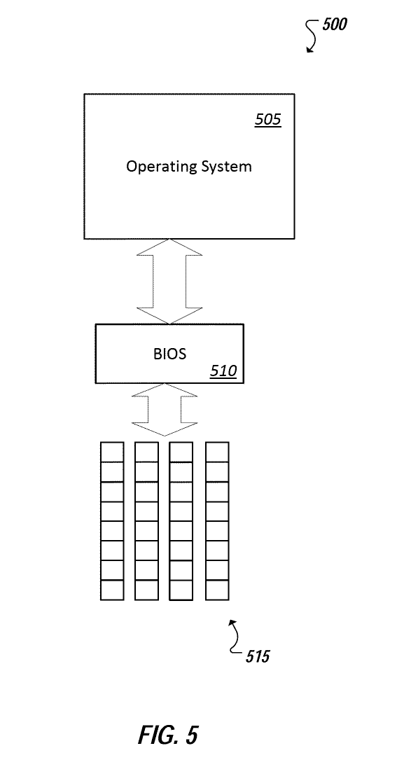

An SoC and corresponding I/O solutions can be provided in a variety of different computing devices, including tablets, phones, and other low cost embedded platforms, but also to current and next generation PCs, server systems, among other examples. Turning to FIG. 5, a simplified block diagram 500 is shown of a system including an operating system of a computing system employing multiple integrated devices, such as an SoC including multiple IP blocks. The computing system can include an operating system 505 adapted to configure the devices on the system. A Basic I/O System (BIOS) 510 can be provided that can initialize and test system hardware components. Configuration information for the various devices can be stored in registers 515 (e.g., Base Address Registers (BARs)) of the devices. The BIOS can read the registers at run time (e.g., at boot up) and pass information to the OS.

A fabric agent's registers can be mapped to memory locations. For instance, a fabric agent's registers can reside in any one of memory mapped space, I/O mapped space, configuration space, and private configuration register (CR) space. In memory mapped space, an address field can be the offset within the BAR indicated by the BAR Number field. In some instances, access to an agent's memory mapped space may be one of a 32- or 64-bit address, depending on the BAR size of the device. An agent's BAR numbers on sideband may or may not match its BARs on the primary interface. For I/O mapped space, the address field can be an offset within the BAR indicated by the BAR Number field and may or may not match its BARs on the primary interface. In configuration space, the address field can indicate the register offset and can be a 16-bit address field. For CR space, the address can indicate a flat 16-bit or 48-bit space, among other example implementations.

Device drivers can use APIs provided by the operating system to access the configuration space of the device. Device addressing can be enabled by mapping the device into the system's I/O port address space or memory-mapped address space. The system's firmware, device drivers or the operating system can program the BARs to inform the device of its address mapping by writing configuration commands to a controller. In some cases, the devices may be in an inactive state upon system reset and not yet have addresses assigned to them by which the operating system or device drivers can communicate with them. In some cases, the BIOS or the operating system can be utilized to assign addresses to the BARs of the devices when the system is booted, among other examples.

In some implementations, an on-chip system fabric architecture can be defined for use in interconnecting blocks in an SoC. The fabric can provide a standardized interface to enable IP blocks to be shared across CPU, platform controller hub (PCH), and SoC products. This can allow IP blocks to be reused across a spectrum of CPU, PCH, and SoC products based on specific market needs. An IP block compliant with the fabric can connect to the fabric as an agent. A master interface of the agent can include master control signals that provide information to the fabric for flow control on the master interface, and arbitration and decoding of transactions. The information on the master control interface can be used by the fabric, and may sometimes be forwarded by the fabric to a fabric target interface. The master interface can also utilize command and data signals. The information on these signals can be forwarded by the fabric to the target command and data interfaces of the selected target agent. In addition to the command and data interfaces, the target interface also has a control interface that can carry flow control and decode information between the fabric target interface and the agent target interface.

A fabric can define a decode phase to be used to determine a target of a transaction. The decode phase is used to determine the target of a transaction. The fabric can use the decode phase to associate credits required by a particular transaction with the credits available by the decoded target, and to direct the put signal to the decoded target when a transaction has been granted in a command phase. Multiple transaction decode options can be supported including one or more of source decode, fabric decode, target decode, and subtractive decode.

Source decode can be supported in some implementations. With source decode, a fabric can be presented with information of the final destination of a transaction. The fabric receiving the transaction need not decode the command to identify the intended target. The decoded information can be conveyed via a Destination ID field. If an agent implements source decode, the agent can decode the target and present this information to the fabric using the Destination ID field on its master control and command interface. The destination information can be sent in the request phase to enable the fabric request arbiter to make routing decisions prior to seeing the command. The fabric can use this information to route the transaction to the destination.

In a multi-hop fabric, this information can be carried across fabrics, to the final fabric on which the eventual target is attached. For instance, an identified destination can be used as “source decode” information by the next fabric to route transactions without having to decode them again. For example, the upper-level fabric can present the Destination ID to the next hop fabric over a target command interface. If the destination agent is attached on another fabric below the current one, the transaction can be forwarded down to the other fabric, and so on until the final target (on the final fabric) is reached.

Fabric decode can also be supported in some implementations. In one example, a point-to-point connection, fabric-based decode is implicit. In a many-to-one fabric, it may also be implicit that the many agents all have the same target. However, if the target is not implicitly known, the fabric may first identify the corresponding transaction command in order to perform the decode. The fabric may acquire the command information, for instance, by using a special show command protocol in which agents expose their command attributes (e.g., of outgoing transactions) to the fabric without unloading commands from their queues. Alternatively, agents can accept an entire transaction into a store-and-forward buffer that gives the fabric access to the command. In either case, the fabric can maintain mirror or shadow copies of all configuration registers of the attached target agents in order for the fabric to perform the decode. The mechanism by which the shadow registers are programmed can be fabric specific. For instance, shadow registers can be programmed by either snooping the configuration transaction to the agent, using the sideband message interface to gather the required information during configuration and enumeration, or by using other fabric-specific mechanisms.

In some implementations, a fabric can identify a target based on the target's bus, device, and function number (as well as, in some cases, the target's root space identifier). To decode transactions involving a PCIe P2P bridge, the fabric can additional maintain a shadow copy of the bridge's secondary and subordinate bus number registers. Indeed, the fabric can maintain shadow copies of BARs of endpoint agents, base and limit registers of bridges, and other registers, such as Memory Space Enable (MSE), IO Space Enable (IOSE), Power Management Power State, and Function Level Reset (FLR) registers of agents, among other examples.

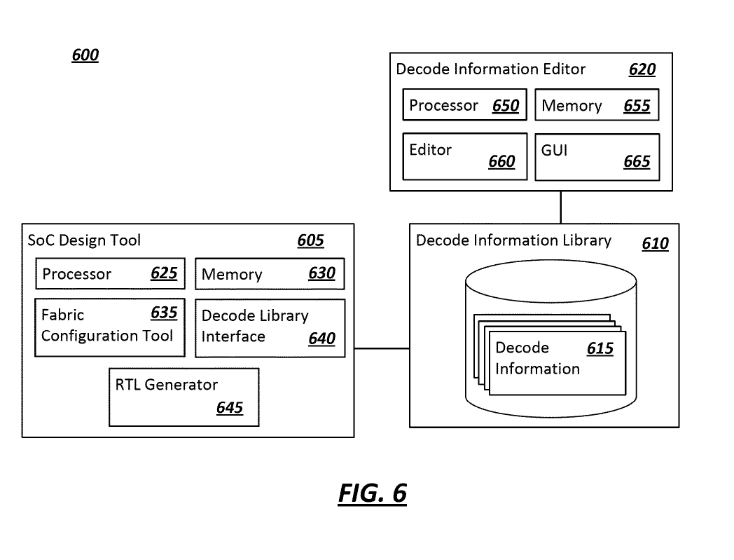

Turning to FIG. 6, a simplified block diagram 600 is shown illustrating an example system that can be used in the development of an SoC and SoC fabric. A fabric configuration tool 605 can be provided that is capable of generating a design abstraction of the fabric and, in some cases, also the SoC, for instance, using a hardware description language (HDL). To simplify use of the SoC design tool 605, and streamline the design and configuration of fabrics using the SoC design tool 605, a decode information library 610 can be provided that includes multiple volumes, or entries 615, of potential decode information that can be included in and used in the generation of a particular fabric definition generated by the SoC design tool 605. Decode information can include any information that might be required by the eventual fabric (generated from the HDL definition) to decode the various IP blocks (and related transactions) that are to be connected to the fabric. Further, a decode information editor 620 can be provided to allow a user to interface with decode information library 615, define decode information to associate with IP blocks in particular instances of a fabric, and even edit the decode information 620.

In some implementations, a fabric configuration tool 605 can include one or more processors 625, one or more memory elements 620, and additional components, implemented in software and/or hardware, such as a fabric configuration tool 630, decode library interface 640, and HDL generator 645. The fabric configuration tool 630 can consume decode information entries 615 provided through decode information library 610. In some cases, decode library interface 640 can provide an API allowing the fabric configuration tool 630 to access and utilize the decode information entries that correspond to IP blocks identified for connection to a fabric. The fabric configuration tool 630 can define characteristics of the fabric based on the designated decode information 615 to generate a model of the fabric to support the identified IP blocks. In some cases the model can be provided as or incorporated in a design abstraction generated by the SoC design tool 605, such as an abstraction embodied in one or more HDL objects that can be used to define the pre-silicon SoC.

In digital circuit design, HDLs can define design abstractions of circuits and on-chip systems to model the structure, design and operation of electronic circuits, including systems of circuits, such as would be implemented in a fabric or SoC. An HDL can enable a precise, formal description of an electronic circuit that allows for the automated analysis, simulation, and simulated testing of the modeled circuit. An HDL object, or “program,” can be consumed by fabrication tools for use in generating the actual circuits modeled by the HDL object. For instance, an HDL program can be compiled (e.g., using tool 605 or another tool) into a lower level specification of physical electronic components, such as masks used to fabricate the modeled integrated circuit(s). Some SoC design tools (e.g., 605) can automate the generation of HDL objects, based on inputs provided to it that correspond to functionality and devices to be implemented on an SoC, including its fabric. HDLs can be used to write executable specifications for hardware and tools can be provided that can implement the underlying semantics of language statements within an HDL object to provide a hardware designer (or design tool) with the ability to model a corresponding piece of hardware (e.g., an SoC) before it is created physically (e.g., in silicon).

In one example, SoC design tool 605 (e.g., using fabric configuration tool 635 or HDL generator 645) can generate a register-transfer level (RTL) HDL object. RTL is a design abstraction that can model a synchronous digital circuit in terms of the flow of digital signals (data) between hardware registers, and the logical operations performed on those signals. RTL can be used in some HDLs to create high-level representations of a circuit, from which lower-level representations and ultimately actual wiring can be derived. An RTL HDL object can model circuit elements including registers and combinational logic. Registers (e.g., implemented as flip-flops) can synchronize the circuit's operation to the edges of the clock signal, and implement memory properties for the circuit. Combinational logic can provide the logical functions in the circuit (e.g., as implemented through corresponding logic gates), among other examples. An electronic design automation (EDA) too can consume the description provided through an HDL object to translate the object into an equivalent hardware implementation file for use in designing and fabricating the corresponding printed circuit boards and integrated circuits (e.g., of an SoC).

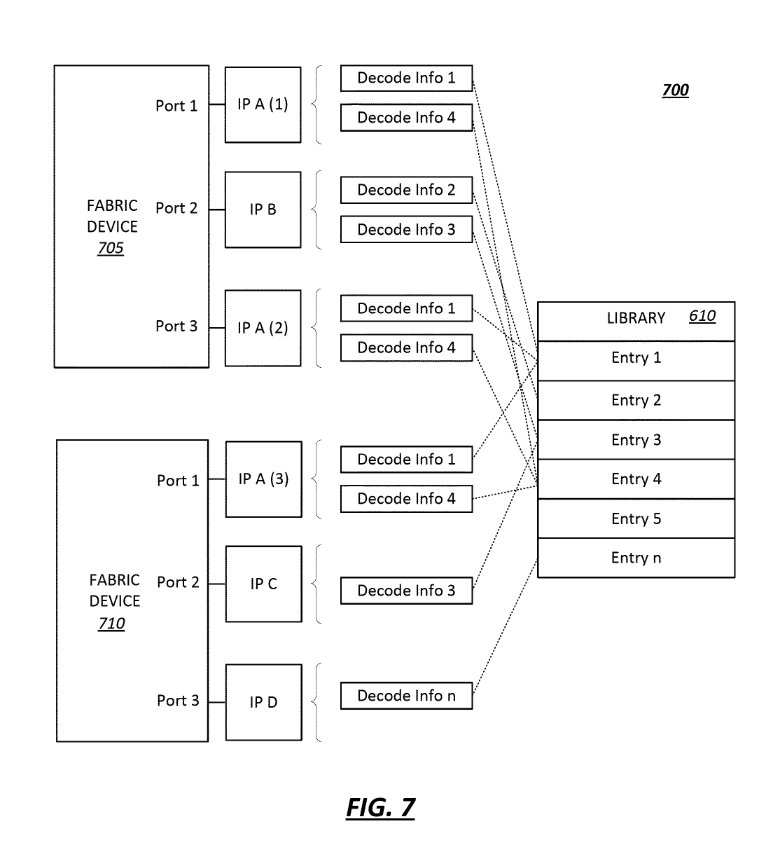

Turning to FIG. 7, a simplified block diagram 700 is shown illustrating the linking of entries of a decode information library to ports of a fabric. In this particular example, the fabric can be implemented using one or more fabric devices (e.g., 705, 710) which can be incorporated in a SoC. For instance, a first fabric device 705 can include Ports 1, 2, and 3. Each port can be utilized to connect a respective IP block to the fabric. In this example, Port 1 includes an instance of an IP block “A” (IP A(1)), Port 2 includes an instance of an IP block “B” (IP B), and Port 3 includes a second instance of IP block “A” (IP A(2)). Each IP block can support one or more functions that may require decode. The functions can include defined functions within a protocol (e.g., a function defined in a specification of PCIe). An IP block can also include one or more distinct devices, each device configured to support one or more respective functions. Accordingly, a user can define the features of an IP block, in part, by selecting decode information entries from decode information library 610 and associating these with the IP block. For instance, each entry can include all of the decode information that would be needed by a fabric to decode transactions for a particular device. In other words, each entry can correspond to a respective pre-defined device. Various IP blocks can each implement the same device and thus utilize the same corresponding entry in the decode information library. Alternatively, each decode information library entry can correspond to one of a set of pre-defined functions. For instance, a set of defined PCI/PCIe functions can be defined for a fabric supporting a PCI-based protocol. Various different IP blocks may include circuitry and logic to perform one or more of the same functions and can each be associated with a corresponding decode information library entry.

For instance, IP block “A” can be a block provided by an entity and the block can be configured to perform two distinct functions within a set of defined functions. Accordingly, a user can identify a pre-defined entry, Entry 1, in the library of decode information 610 that corresponds to a first one of the two functions supported by IP block “A” and can identify another pre-defined decode information entry, Entry 4, that corresponds to this second function. Entry 1 can include all of the decode information that would be needed in a particular implementation of a fabric to decode transactions for that function. Similarly, Entry 4 can include a sufficient collection of decode information to allow the fabric to decode transactions for the second function. The user can select the appropriate decode information entries to associate the entries with the IP block. Further, the associations between the entries and the IP block can be saved and conveniently reused for any other instances of the IP block in the fabric, or another fabric utilizing a similar protocol. For instance, a user can create the association between the IP block “A” and one or more reusable library entries (e.g., Entries 1 and 4) a single time and reuse this association for each instance of the IP block (e.g., IP A(1), IP A(2), IP A(3)).

To configure a fabric, the set of decode information entries that correspond to the IP block to be connected to a given fabric port can be assigned to that port. For instance, for Port 2 of fabric 705, library entries Entry 2 and Entry 3 are assigned to Port 2 to provide the decode information for two functions (or alternatively, two devices) implemented by IP block B. An SoC design tool 605 can utilize the information in the assigned decode information entries to determine configuration of the fabric corresponding to the port (e.g., Port 2). This can include, for instance, the provision of memory and/or flip flops in the fabric to accommodate shadow or mirror registers of the corresponding device or function of the IP block to be connected to the port. Corresponding, library entries can be defined for each of the ports of the fabric that are to have an IP block connected to it. An SoC design tool can utilize the information in the assigned entries to generate an HDL object that models a fabric device (e.g., 705 or 710) that is configured to support a set of IP blocks (e.g., IP A(1), IP B, and IP A(2) or IP A(3), IP C, and IP D respectively) to be connected to ports of the fabric device (e.g., on an SoC).

In some implementations, a library of decode information (e.g., 610) can be extensible. As noted above, in some examples, the entries of a library of decode information can include a subset that corresponds to a discrete set of functions (or devices) that are defined in a specification of a protocol, such as PCIe. However, some IP blocks (e.g., IP D) may include functions (or devices) outside of the discrete set, such as proprietary or custom functions that are tuned for compatibility with the fabric. In such instances, custom decode information entries (e.g., Entry n) can be defined. The custom entries to be incorporated in a custom IP block can also be assigned to a port (that is to connect to the custom IP block) and can be utilized by a SoC design tool to generate an HDL object that models the port configured to support the custom IP block.

Returning to FIG. 6, various tasks can be performed relating to a decode information library 610 using a library editor 620. For instance, associations between a particular IP block and one or more library entries can be defined, library entries can be edited, new entries (including custom entries) can be generated, among other tasks. In one example, a library editor 620 can be implemented using one or more processor devices 650, one or more memory elements 655, and one or more components implemented in software and/or hardware can be provided that facilitate functionality of the library editor 620. For instance, an editor 660 can be provided to edit or generate library entries, among other functionality. Further, a graphical user interface (GUI) 665 can be provided allowing users to interact with the decode information library 610.

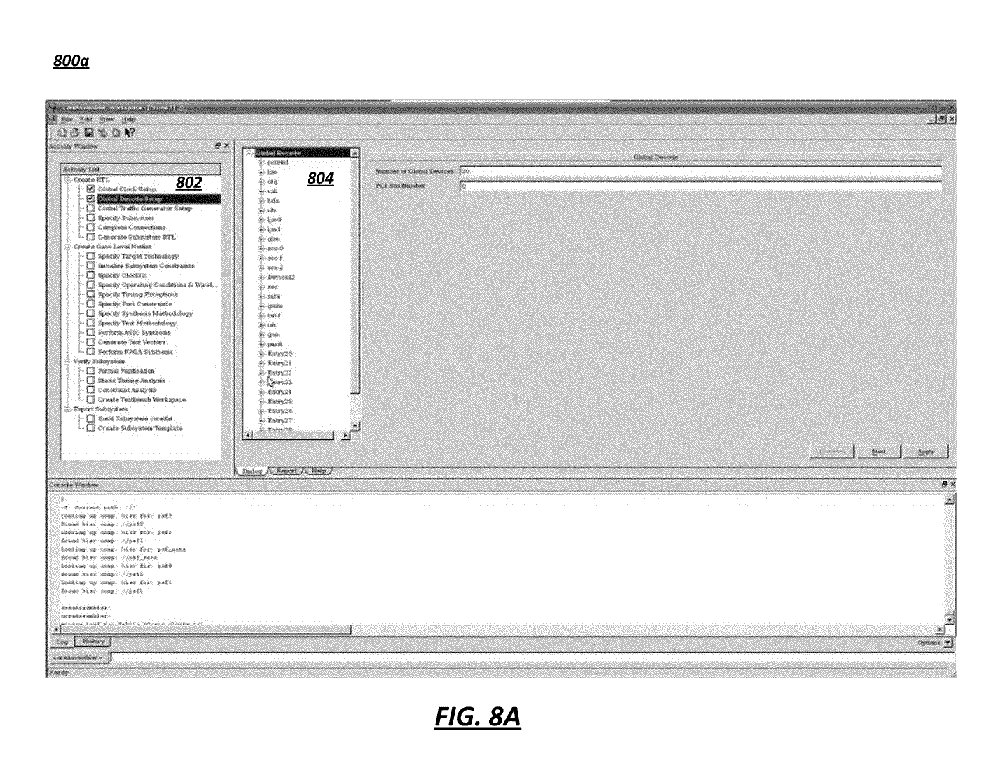

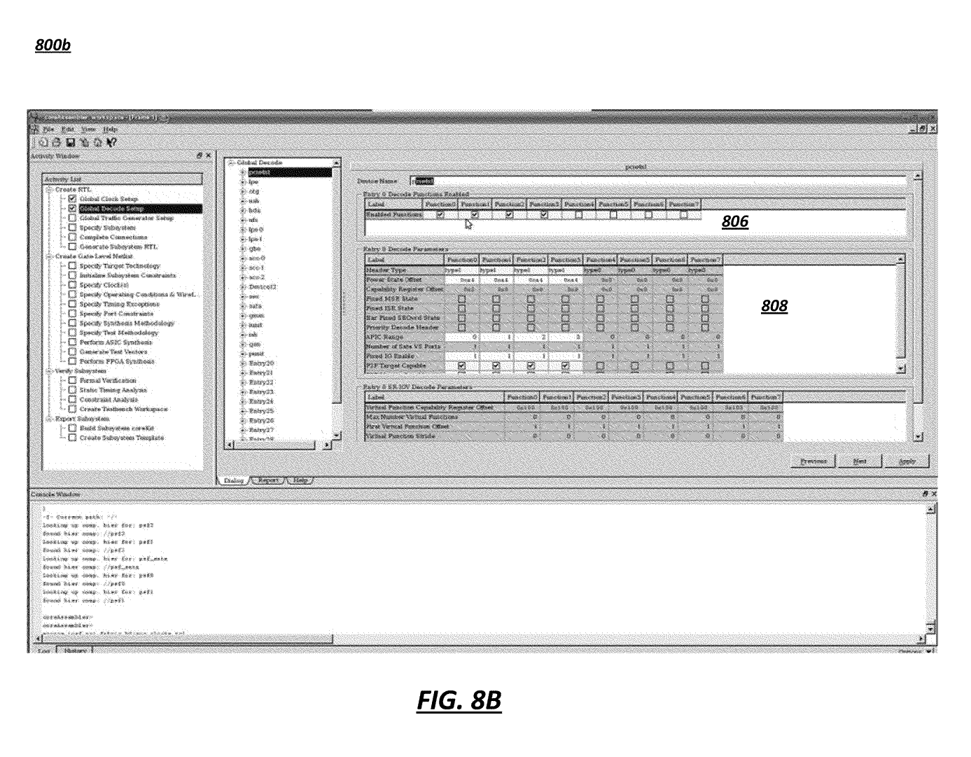

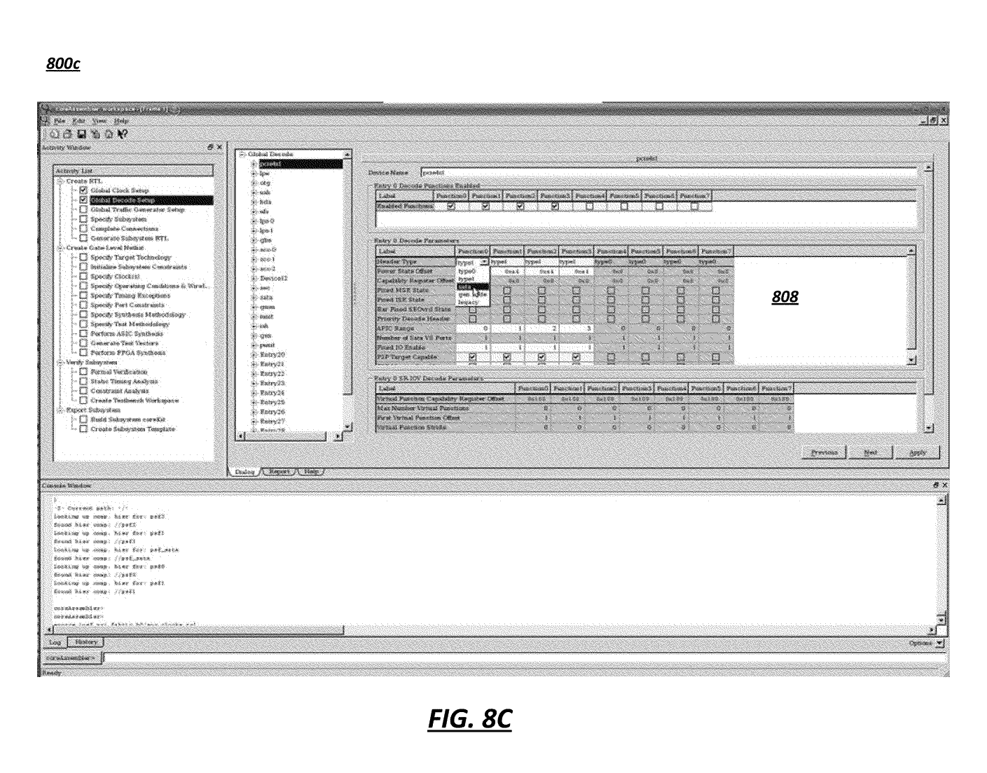

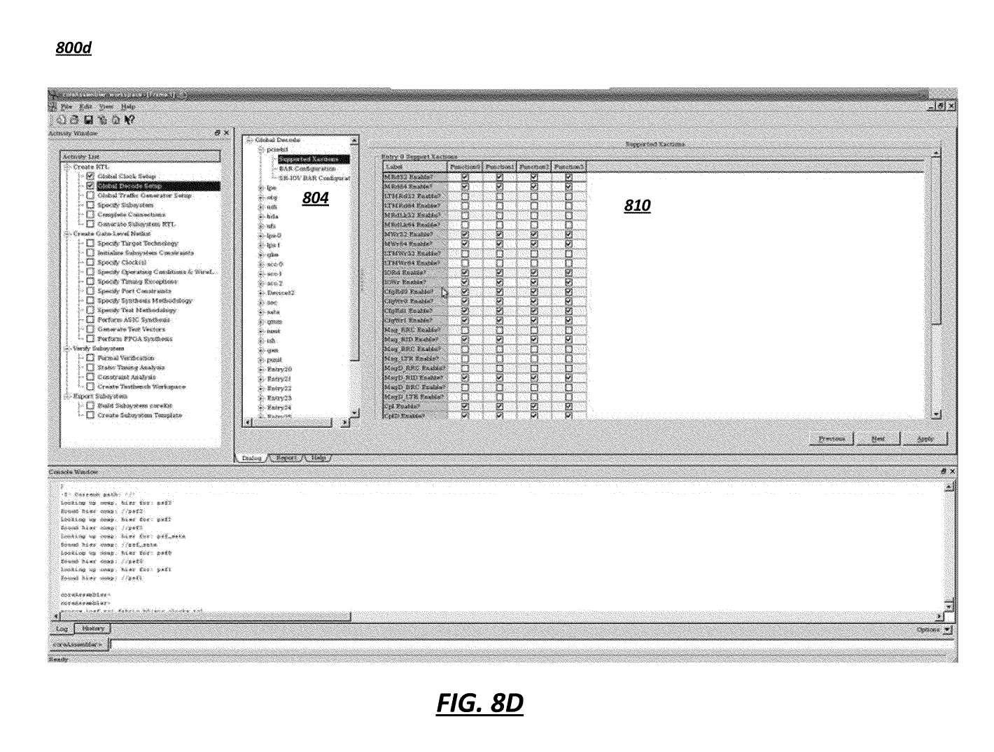

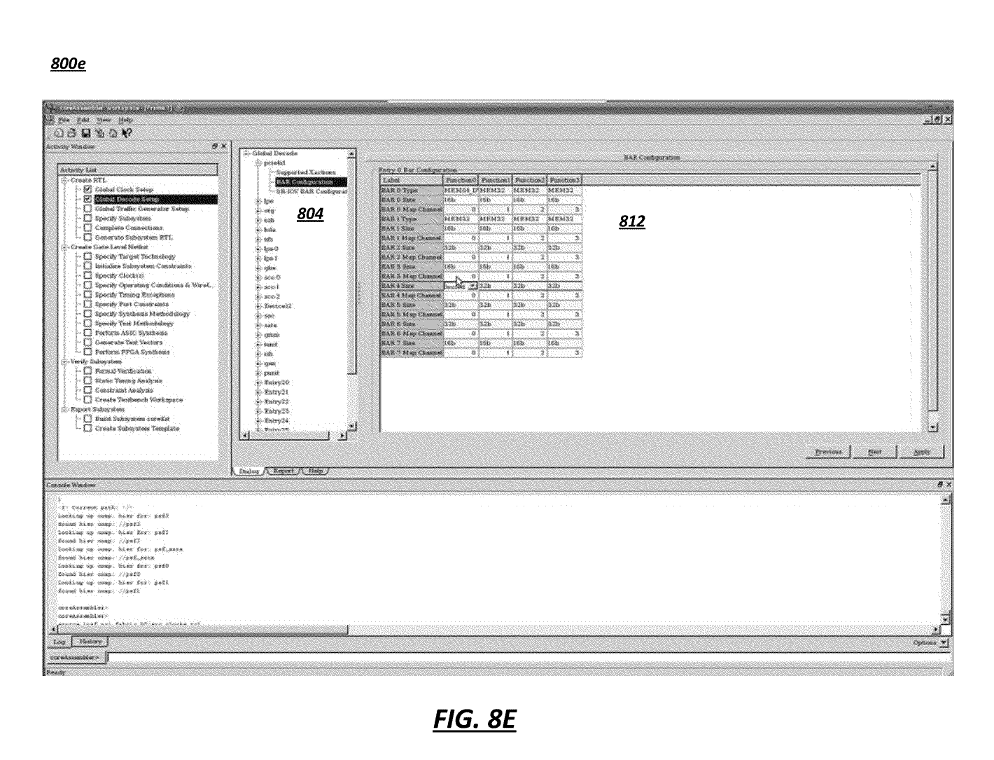

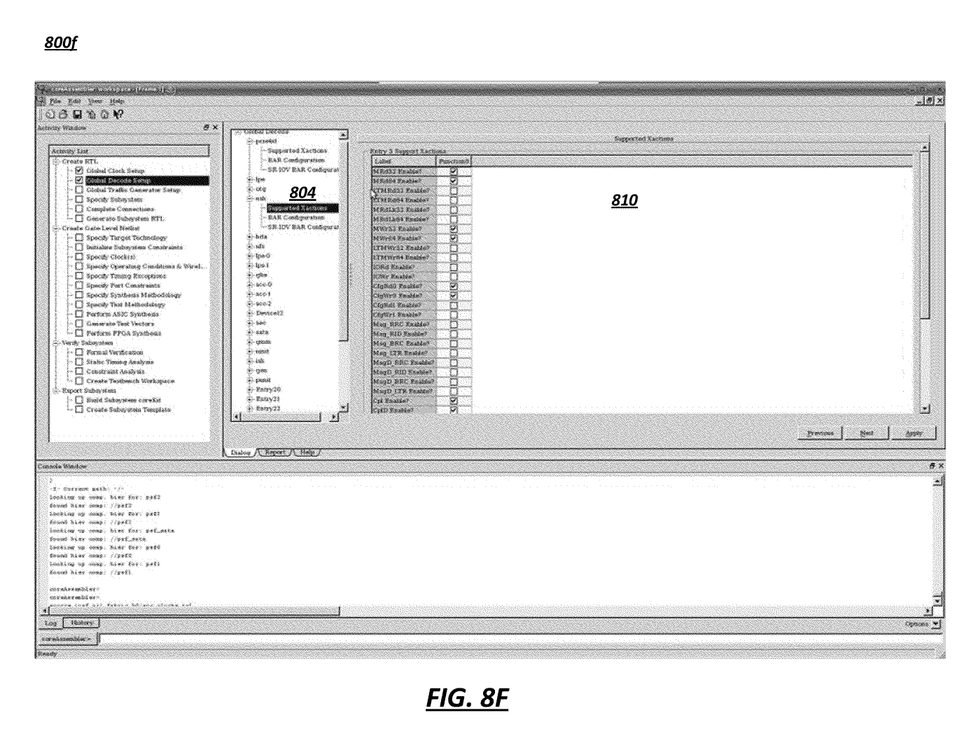

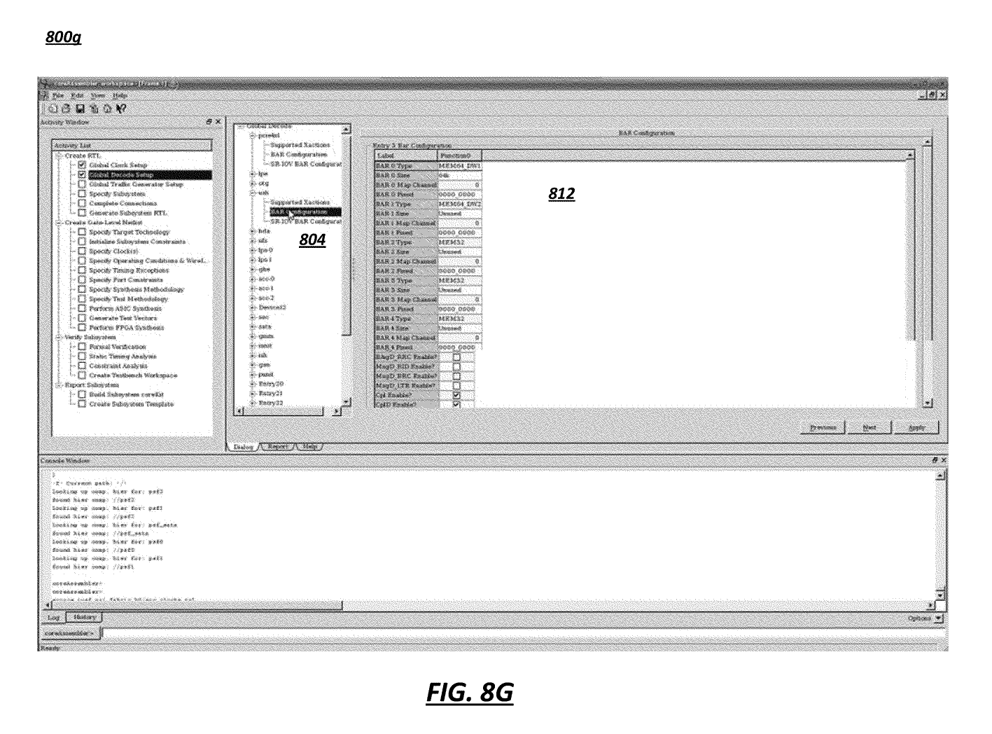

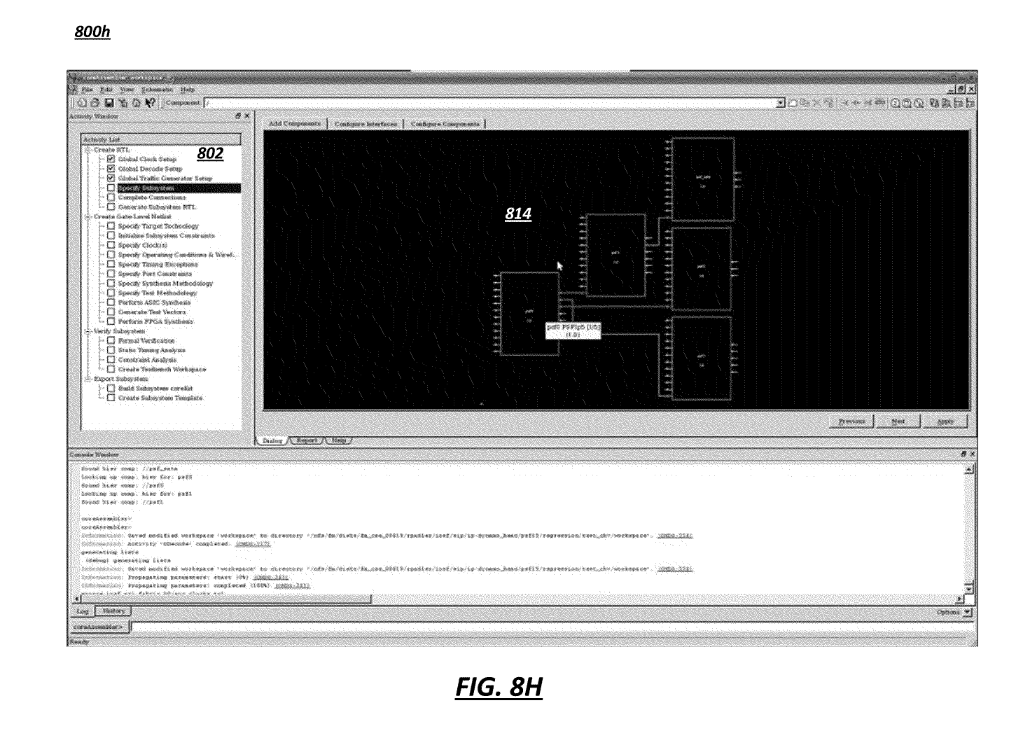

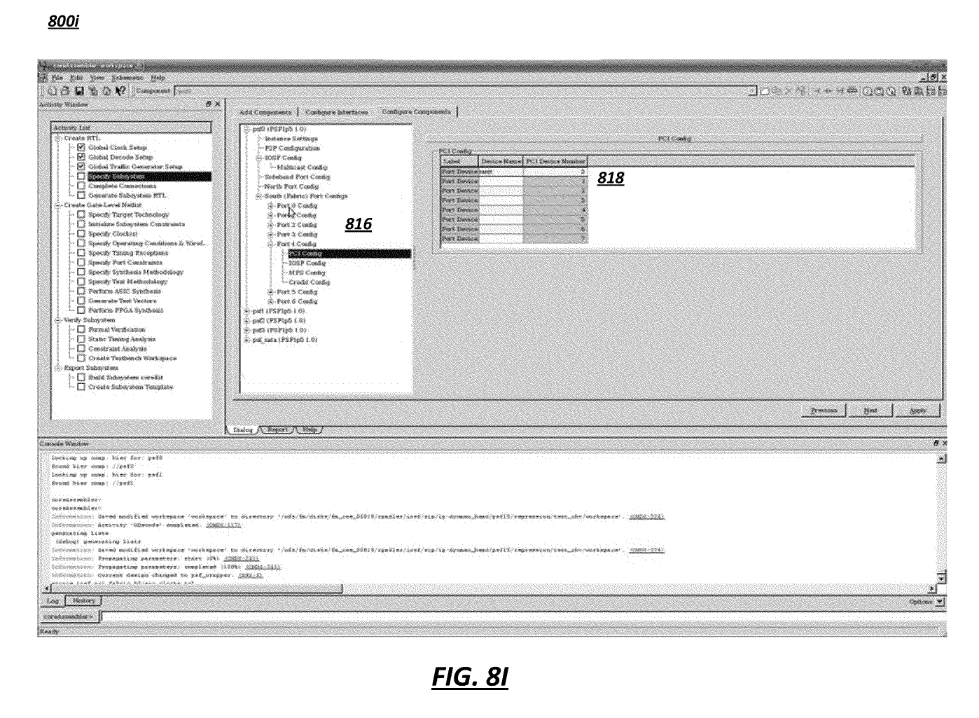

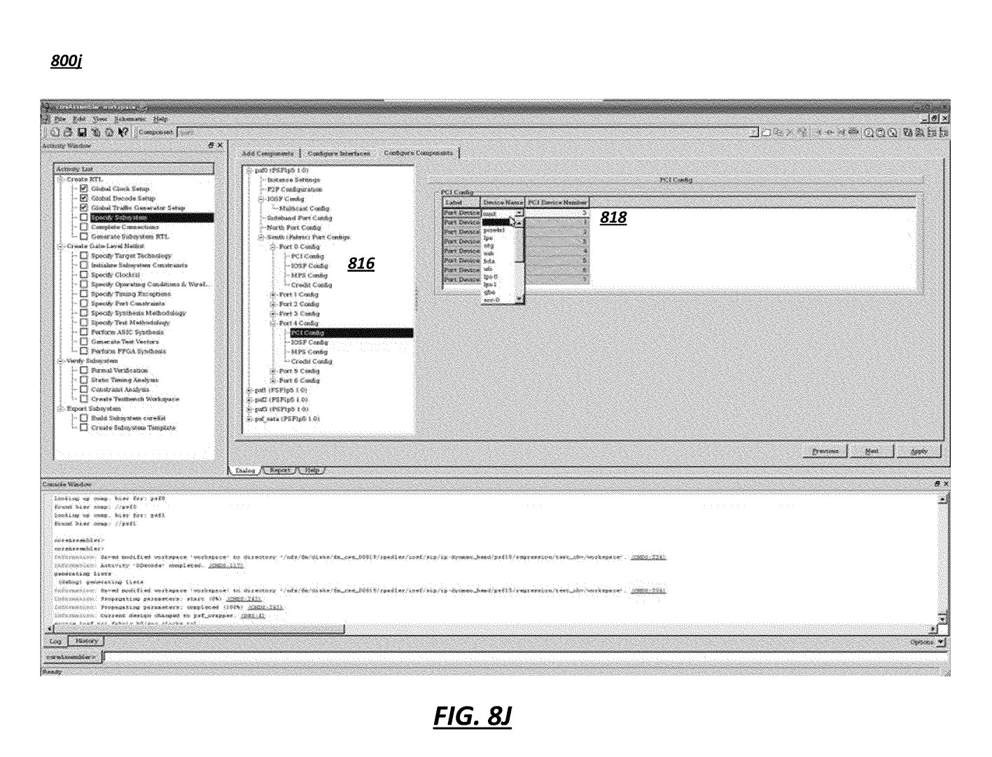

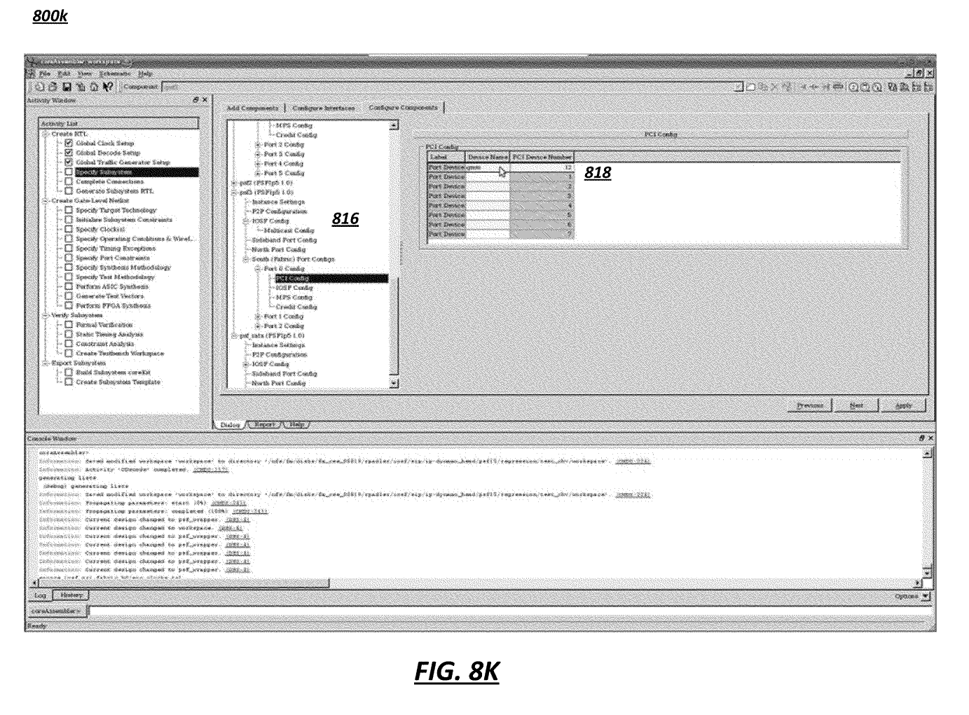

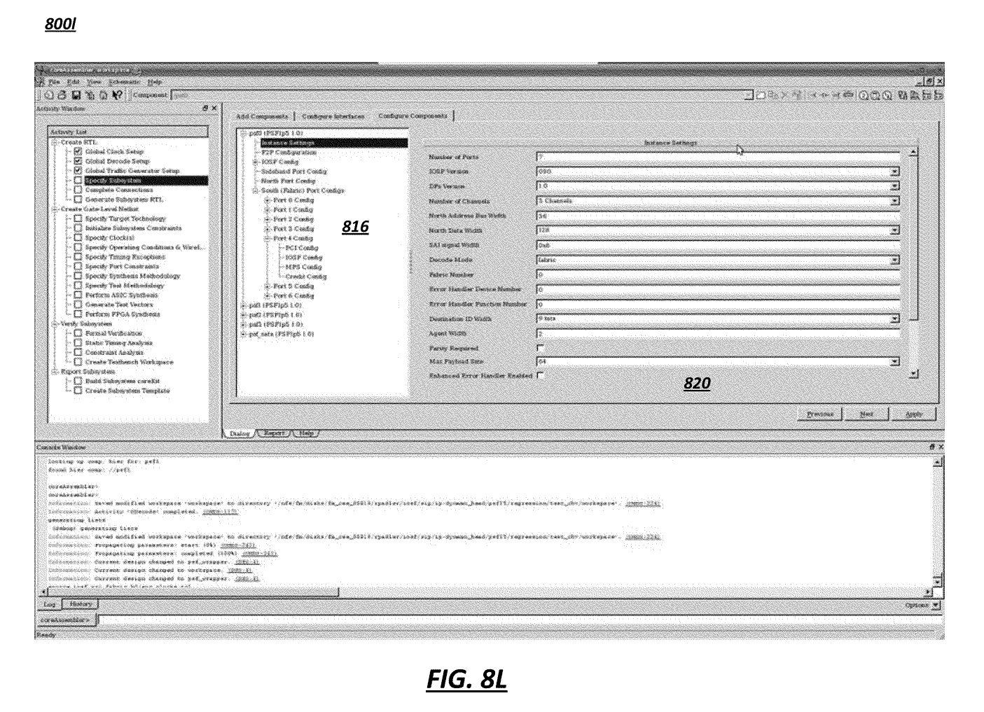

FIGS. 8A-8L illustrate screenshots 800a-1 of an example software tool for use with a library of decode information. For instance, FIG. 8A shows a view of a screenshot 800a with a window 802 that includes an activity list from which a user can select an activity to perform relating to a decode information library. In this example, a user has selected Global Decode Step sub-action within a Create RTL activity. This action can include the review and assignment of decode information library entries corresponding to various devices (or for various functions). A window 804 can be presented to summarize the entries of a decode information library. A user can select a particular one of the entries to view the details of the entry. For instance, FIG. 8B shows a view of a user interface screenshot 800b, illustrating a user's selection of a particular library entry “pcie4×1” and the corresponding presentation of attributes (in windows 806, 808) of the selected library entry. For instance, a window 806 can summarize which of a set of defined functions capable of being supported in a fabric have been enabled for the device “pcie4×1”. These selected functions can describe the functions that are supported by this device. A user can, in some instance, be authorized to edit the library entry corresponding to the device by selecting and/or unselecting functions in the set (e.g., through interactions with controls (e.g., checkboxes) of window 806). Further, window 808 can provide a view of the supported functions (e.g., Functions 0-7) allowing a user to edit the decode information on a per-function basis (e.g., as shown in the example 800c of FIG. 8C).

Decode parameters can be defined in a decode information library, such as parameters that describe configuration space to be included in a device for the function. For instance, parameters can describe the type of the BAR (e.g., I/O or memory space BAR), the size of the BAR of the device (e.g., 1 MB, 4 kB, etc.), among other information. Further, the decode information entry can describe all of the transactions (e.g., configuration transactions, I/O transactions, memory reads, memory writes, atomic operations, etc.) supported in connection with the function (or device), as well as whether the transaction is handled in a target or master mode, the size of the transaction (e.g., 64B Wr, 4B MWr) (on a per transaction type basis (e.g., Posted, Non-Posted, Completion)), among other example information. Accordingly, transaction information can be defined at a per function basis.

Turning to FIG. 8D, a view 800d of a user interface is shown. A user can select to view the decode information of an entry defined for a device or function at a more granular level. For instance, a user can select to view the supported transactions of a device “pcie4×1” in window 804 and cause the display of window 810. In this example, window 810 shows, for each function supported by a device (e.g., “pcie4×1”), which of a defined set of transactions are supported by each function. For instance, transactions can be selected or deselected from the listing of possible transactions shown for each function (e.g., Functions 0-3) according to which transactions are or are not supported by the corresponding function. Additionally, a user can edit the defined transactions supported by each function (e.g., through window 810).

FIG. 8E shows another view 800e of a user interface. In this example, a user selects (in window 804) to view BAR configuration details of a particular device (e.g., “pcie4×1”). A corresponding window 812 can be presented in response to show the decode information describing the BAR configuration for each supported function (e.g., Functions 0-3) of the device. For instance, for each BAR corresponding to the function, the BAR type, size, and channel can be defined, among other potential information. As with supported transactions, virtualization BAR configuration, and other attributes, BAR configuration information can be viewed and edited (e.g., by an authorized user) through interfaces such as window 812.

Decode information can be viewed and edited for any of the decode information entries in a library. For instance, FIGS. 8F and 8G show the selection of another device (e.g., “uah”) through window 804 and the presentation (e.g., in windows 810, 812) of details of a corresponding decode information entry. These details can likewise be edited to modify or supplement the device's decode information entry through the GUI.

Turning to FIG. 8H, another view 800h of a GUI is shown including an interface 814 for selecting a particular fabric device to which decode information entries are to be assigned. In one example, a user can navigate to the window 814 by selecting a Specify Subsystem activity from Activity List window 802. As illustrated in the particular example of FIG. 8H, multiple fabric devices may be intended for inclusion in a SoC according to a particular design. Each fabric device can include one or more ports for connecting the fabric device to one or more IP blocks. Through window 814, a particular one of the fabric devices can be selected, for which decode information is to be assigned. In response to selecting one of the fabric devices, one or more additional windows (e.g., 816, 818) can be presented to show fabric ports corresponding to the selected fabric device, such as shown in the example of FIG. 8I. Through window 816 a user can select a particular one of the ports of the selected fabric device and a configuration window 818 can be presented corresponding to the selected port. Through configuration window 818, a user can select which devices are included in the IP block that is to be connected to the port (e.g., as shown in the example of FIG. 8J). The selection of a device can cause a corresponding decode information entry (e.g., designated by a “device name” pointer) to be assigned to the selected port. In cases where the IP block includes multiple devices, multiple devices can be selected (in window 818) and multiple decode information entries assigned to the port. In implementations where a decode information library is organized on a per-function basis (i.e., rather than on a per device basis), a user can select each of the functions supported by the IP block that is to be connected to a fabric port and corresponding library entries can be assigned to the port. In either instance, a user can also define a number identifier for each selected device (or function) (e.g., through interaction with window 818). In some cases, multiple instances of the same device or function can be defined for the same IP block and, thus, port. Accordingly, each instance (device or function) can be assigned (by a user) a unique number identifier for the port (to give the corresponding decode instance a “personality”). This can permit that each function (and corresponding decode information entry) is identified by a unique bus identifier, device identifier, and function identifier combination. Further, as shown in FIG. 8K, decode information can be similarly assigned to each port of a selected fabric (again, through windows 816, 818).

Turning now to FIG. 8L, in addition to providing user interfaces for editing and assigning decode information library entries, user interfaces can be provided to define aspects of the fabric devices (and other components) to be included in n SoC. For instance, as shown in screenshot 800l, a window 820 can be provided to allow a user to define (or edit) attributes of a fabric device to be included in n SoC. Among the attributes that can be defined, a number of fabric ports can be defined. Decode information entries can be assigned to each of the defined ports. Further, attributes can be viewed and edited, for instance, by navigating to a category of attributes using window 802.

As noted above, a user can utilize various user interfaces of design tools, such as those shown in FIGS. 8A-8L, to define attributes of a fabric and/or the SoC in which the fabric is to be incorporated. The attributes can include the attributes included in a set of reusable decode information library entries assigned to ports of the fabric. While other attributes may be entered manually on a fabric device-specific basis, the use of a decode information library can facilitate quick and accurate definition of IP-block-specific decode information for each fabric port. In some instances, a design tool can utilize these inputs to automatically generate an HDL object (such as an RTL HDL object) to model the fabric that is to support the connections to a set of planned IP blocks.

Note that the apparatus′, methods′, and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

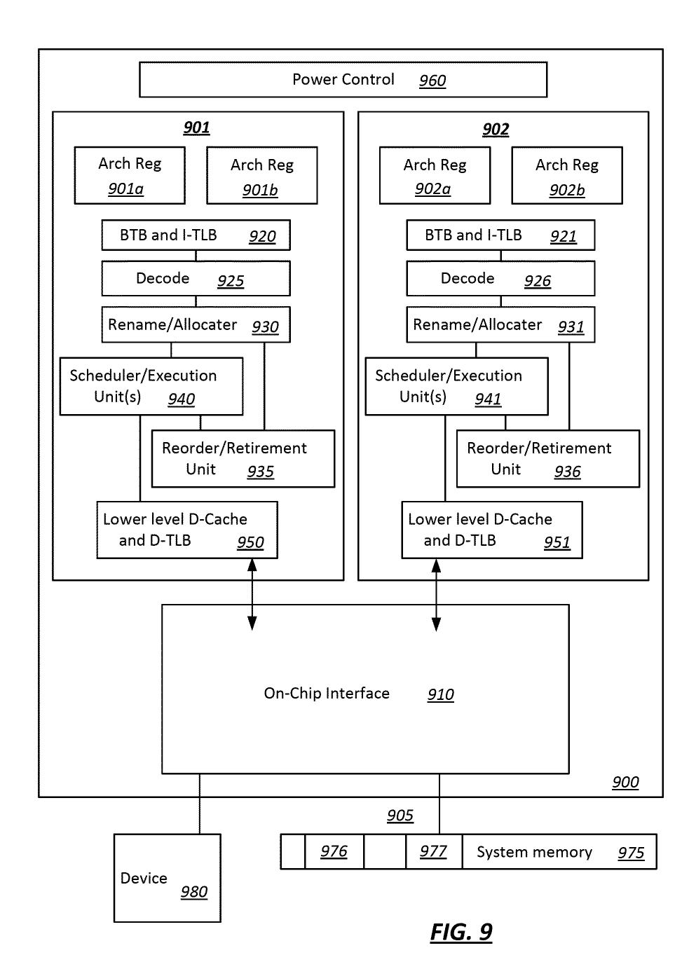

Referring to FIG. 9, an embodiment of a block diagram for a computing system including a multicore processor is depicted. Processor 900 includes any processor or processing device, such as a microprocessor, an embedded processor, a digital signal processor (DSP), a network processor, a handheld processor, an application processor, a co-processor, a system on a chip (SOC), or other device to execute code. Processor 900, in one embodiment, includes at least two cores—core 901 and 902, which may include asymmetric cores or symmetric cores (the illustrated embodiment). However, processor 900 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 900, as illustrated in FIG. 9, includes two cores—core 901 and 902. Here, core 901 and 902 are considered symmetric cores, i.e. cores with the same configurations, functional units, and/or logic. In another embodiment, core 901 includes an out-of-order processor core, while core 902 includes an in-order processor core. However, cores 901 and 902 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 901 are described in further detail below, as the units in core 902 operate in a similar manner in the depicted embodiment.

As depicted, core 901 includes two hardware threads 901a and 901b, which may also be referred to as hardware thread slots 901a and 901b. Therefore, software entities, such as an operating system, in one embodiment potentially view processor 900 as four separate processors, i.e., four logical processors or processing elements capable of executing four software threads concurrently. As alluded to above, a first thread is associated with architecture state registers 901a, a second thread is associated with architecture state registers 901b, a third thread may be associated with architecture state registers 902a, and a fourth thread may be associated with architecture state registers 902b. Here, each of the architecture state registers (901a, 901b, 902a, and 902b) may be referred to as processing elements, thread slots, or thread units, as described above. As illustrated, architecture state registers 901a are replicated in architecture state registers 901b, so individual architecture states/contexts are capable of being stored for logical processor 901a and logical processor 901b. In core 901, other smaller resources, such as instruction pointers and renaming logic in allocator and renamer block 930 may also be replicated for threads 901a and 901b. Some resources, such as re-order buffers in reorder/retirement unit 935, ILTB 920, load/store buffers, and queues may be shared through partitioning. Other resources, such as general purpose internal registers, page-table base register(s), low-level data-cache and data-TLB 915, execution unit(s) 940, and portions of out-of-order unit 935 are potentially fully shared.

Processor 900 often includes other resources, which may be fully shared, shared through partitioning, or dedicated by/to processing elements. In FIG. 9, an embodiment of a purely exemplary processor with illustrative logical units/resources of a processor is illustrated. Note that a processor may include, or omit, any of these functional units, as well as include any other known functional units, logic, or firmware not depicted. As illustrated, core 901 includes a simplified, representative out-of-order (OOO) processor core. But an in-order processor may be utilized in different embodiments. The OOO core includes a branch target buffer 920 to predict branches to be executed/taken and an instruction-translation buffer (I-TLB) 920 to store address translation entries for instructions.

Core 901 further includes decode module 925 coupled to fetch unit 920 to decode fetched elements. Fetch logic, in one embodiment, includes individual sequencers associated with thread slots 901a, 901b, respectively. Usually core 901 is associated with a first ISA, which defines/specifies instructions executable on processor 900. Often machine code instructions that are part of the first ISA include a portion of the instruction (referred to as an opcode), which references/specifies an instruction or operation to be performed. Decode logic 925 includes circuitry that recognizes these instructions from their opcodes and passes the decoded instructions on in the pipeline for processing as defined by the first ISA. For example, as discussed in more detail below decoders 925, in one embodiment, include logic designed or adapted to recognize specific instructions, such as transactional instruction. As a result of the recognition by decoders 925, the architecture or core 901 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 926, in one embodiment, recognize the same ISA (or a subset thereof). Alternatively, in a heterogeneous core environment, decoders 926 recognize a second ISA (either a subset of the first ISA or a distinct ISA).

In one example, allocator and renamer block 930 includes an allocator to reserve resources, such as register files to store instruction processing results. However, threads 901a and 901b are potentially capable of out-of-order execution, where allocator and renamer block 930 also reserves other resources, such as reorder buffers to track instruction results. Unit 930 may also include a register renamer to rename program/instruction reference registers to other registers internal to processor 900. Reorder/retirement unit 935 includes components, such as the reorder buffers mentioned above, load buffers, and store buffers, to support out-of-order execution and later in-order retirement of instructions executed out-of-order.

Scheduler and execution unit(s) block 940, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 950 are coupled to execution unit(s) 940. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 901 and 902 share access to higher-level or further-out cache, such as a second level cache associated with on-chip interface 910. Note that higher-level or further-out refers to cache levels increasing or getting further way from the execution unit(s). In one embodiment, higher-level cache is a last-level data cache—last cache in the memory hierarchy on processor 900—such as a second or third level data cache. However, higher level cache is not so limited, as it may be associated with or include an instruction cache. A trace cache—a type of instruction cache—instead may be coupled after decoder 925 to store recently decoded traces. Here, an instruction potentially refers to a macro-instruction (i.e. a general instruction recognized by the decoders), which may decode into a number of micro-instructions (micro-operations).

In the depicted configuration, processor 900 also includes on-chip interface module 910. Historically, a memory controller, which is described in more detail below, has been included in a computing system external to processor 900. In this scenario, on-chip interface 910 is to communicate with devices external to processor 900, such as system memory 975, a chipset (often including a memory controller hub to connect to memory 975 and an I/O controller hub to connect peripheral devices), a memory controller hub, a northbridge, or other integrated circuit. And in this scenario, bus 905 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 975 may be dedicated to processor 900 or shared with other devices in a system. Common examples of types of memory 975 include DRAM, SRAM, non-volatile memory (NV memory), and other known storage devices. Note that device 980 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 900. For example in one embodiment, a memory controller hub is on the same package and/or die with processor 900. Here, a portion of the core (an on-core portion) 910 includes one or more controller(s) for interfacing with other devices such as memory 975 or a graphics device 980. The configuration including an interconnect and controllers for interfacing with such devices is often referred to as an on-core (or un-core configuration). As an example, on-chip interface 910 includes a ring interconnect for on-chip communication and a high-speed serial point-to-point link 905 for off-chip communication. Yet, in the SOC environment, even more devices, such as the network interface, co-processors, memory 975, graphics processor 980, and any other known computer devices/interface may be integrated on a single die or integrated circuit to provide small form factor with high functionality and low power consumption.

In one embodiment, processor 900 is capable of executing a compiler, optimization, and/or translator code 977 to compile, translate, and/or optimize application code 976 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

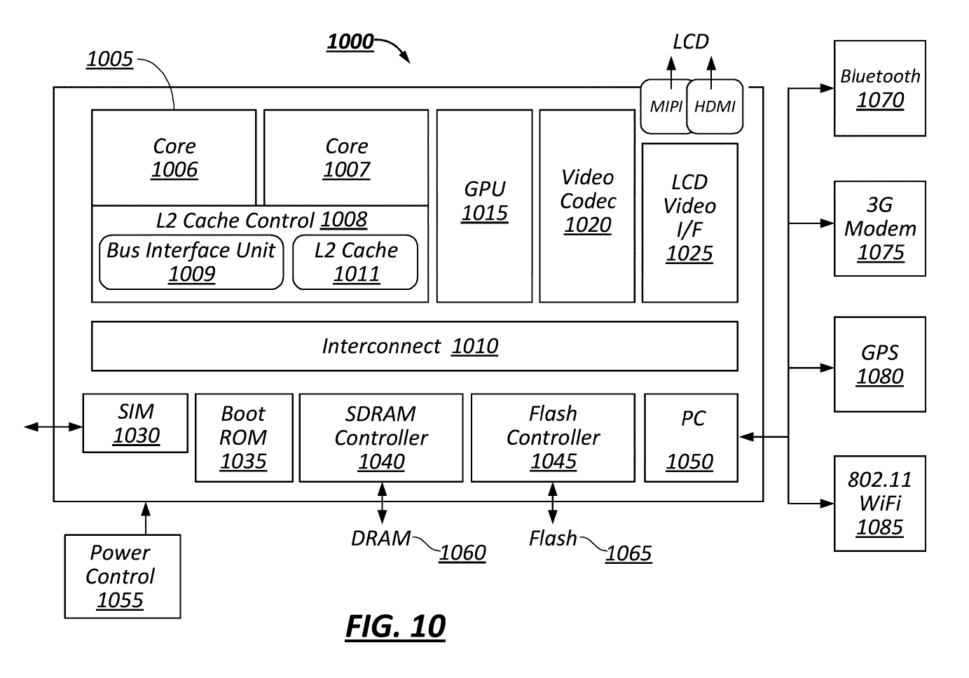

Turning next to FIG. 10, an embodiment of a system on-chip (SOC) design in accordance with the inventions is depicted. As a specific illustrative example, SOC 1000 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1000 includes 2 cores—1006 and 1007. Similar to the discussion above, cores 1006 and 1007 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1006 and 1007 are coupled to cache control 1008 that is associated with bus interface unit 1009 and L2 cache 1011 to communicate with other parts of system 1000. Interconnect 1010 includes an on-chip interconnect, such as an IOSF, AMBA, or other interconnect discussed above, which potentially implements one or more aspects of described herein.

Interface 1010 provides communication channels to the other components, such as a Subscriber Identity Module (SIM) 1030 to interface with a SIM card, a boot rom 1035 to hold boot code for execution by cores 1006 and 1007 to initialize and boot SOC 1000, a SDRAM controller 1040 to interface with external memory (e.g. DRAM 1060), a flash controller 1045 to interface with non-volatile memory (e.g. Flash 1065), a peripheral control 1050 (e.g. Serial Peripheral Interface) to interface with peripherals, video codecs 1020 and Video interface 1025 to display and receive input (e.g. touch enabled input), GPU 1015 to perform graphics related computations, etc. Any of these interfaces may incorporate aspects of the invention described herein.

In addition, the system illustrates peripherals for communication, such as a Bluetooth module 1070, 3G modem 1075, GPS 1085, and WiFi 1085. Note as stated above, a UE includes a radio for communication. As a result, these peripheral communication modules are not all required. However, in a UE some form a radio for external communication is to be included.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, hardware- and/or software-based logic, and a method to identify, for each of a plurality of ports to be defined for an interconnect fabric, a respective computing block to be connected to the port. One or more entries in a library of decode information can be identified for each of the identified computing blocks. An intermediate representation of a fabric of the system on chip can be generated based on the identified entries in the library of decode information.

In at least one example, the library of decode information is to include a plurality of entries.

In at least one example, each entry includes attributes of configuration space of the computing block.

In at least one example, each entry identifies one or more supported functions of the computing block.

In at least one example, the attributes include attributes of a base address register (BAR) of the computing block.

In at least one example, the attributes include a type of the BAR.

In at least one example, the attributes include a size of the BAR.

In at least one example, each entry corresponds to a respective one of a plurality of functions.

In at least one example, the plurality of functions include a set of defined Peripheral Component Interconnect (PCI)-based functions.

In at least one example, the identified entries are to include, for each of the computing blocks, the entries corresponding to functions supported by the respective computing block.

In at least one example, each entry corresponds to a respective one of a plurality of devices included in one of the computing blocks.

In at least one example, the plurality of ports include a first port and a second port, a first computing block is to be connected to the first port, a second computing block is to be connected to the second port, a first set of decode information entries are to be identified for the first computing block, a second set of decode information entries are to be identified for the second computing block, where the first set of decode information entries and the second set of decode information entries have at least one entry in common.

In at least one example, the first set of decode information entries is different from the second set of decode information entries.

In at least one example, the intermediate representation is to represent memory structures of the fabric and the representation of the memory structures is to be based on the entries.

In at least one example, the memory structures are to include shadow registers to store configuration information for use in decoding transactions involving the computing blocks.

In at least one example, the memory structures include a shadow register to mirror at least a portion of a register of at least one of the computing blocks.

One or more embodiments may provide a method, an apparatus, a system, a machine readable storage, a machine readable medium, hardware- and/or software-based logic, including a decode information library manager to maintain a library of decode information that includes a reusable set of entries. Each of the set of entries corresponds to a respective one of a plurality of functions, and each entry is to include information to be used by an interconnect fabric to decode a transaction to involve the corresponding function. An interface can provide entries from the library of decode information to a hardware design tool.

In at least one example, each entry in the set is to describe a type of a corresponding base address register (BAR), size of the corresponding BAR, and attributes of supported transactions corresponding to the respective function.

One or more embodiments may provide a system including at least one processor device, a decode information library, maintained in one or more memory elements, and a hardware design tool. The library of decode information includes a reusable set of decode information entries, each of the set of entries is to correspond to a respective one of a plurality of functions, and each entry is to include decode information to be used by an interconnect fabric to decode a transaction corresponding to the respective function. The hardware design tool consumes one or more entries of the decode information library to generate a hardware description language object to represent an interconnect fabric to interconnect a set of computing blocks.

In at least one example, the hardware design tool is to generate a respective HDL object for each of a plurality of fabrics, where the plurality of fabrics includes a first fabric to interconnect a first set of computing blocks and a second different fabric to interconnect a second, different set of computing blocks.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A computer readable medium comprising code that, when executed, is to cause a computing device to:
identify, for each of a plurality of ports to be defined for an interconnect fabric, a respective computing block to be connected to the port;
identify, for each of the identified computing blocks, one or more entries in a library of decode information; and
generate an intermediate representation of a fabric of the system on chip based on the identified entries in the library of decode information.

2. The medium of claim 1, wherein the library of decode information is to comprise a plurality of entries.

3. The medium of claim 2, wherein each entry comprises attributes of configuration space of the computing block.

4. The medium of claim 3, wherein each entry identifies one or more supported functions of the computing block.

5. The medium of claim 3, wherein the attributes comprise attributes of a base address register (BAR) of the computing block.

6. The medium of claim 5, wherein the attributes comprise a type of the BAR.

7. The medium of claim 6, wherein the attributes comprise a size of the BAR.

8. The medium of claim 2, wherein each entry corresponds to a respective one of a plurality of functions.

9. The medium of claim 8, wherein the plurality of functions comprise a set of defined Peripheral Component Interconnect (PCI)-based functions.

10. The medium of claim 8, wherein the identified entries are to comprise, for each of the computing blocks, the entries corresponding to functions supported by the respective computing block.

11. The medium of claim 2, wherein each entry corresponds to a respective one of a plurality of devices included in one of the computing blocks.

12. The medium of claim 1, wherein the plurality of ports comprise a first port and a second port, a first computing block is to be connected to the first port, a second computing block is to be connected to the second port, a first set of decode information entries are to be identified for the first computing block, a second set of decode information entries are to be identified for the second computing block, wherein the first set of decode information entries and the second set of decode information entries have at least one entry in common.

13. The medium of claim 12, wherein the first set of decode information entries is different from the second set of decode information entries.

14. The medium of claim 1, wherein the intermediate representation is to represent memory structures of the fabric and the representation of the memory structures is to be based on the entries.

15. The medium of claim 14, wherein the memory structures are to comprise shadow registers to store configuration information for use in decoding transactions involving the computing blocks.

16. The medium of claim 15, wherein the memory structures comprise a shadow register to mirror at least a portion of a register of at least one of the computing blocks.

17. An apparatus comprising:
a decode information library manager to:
maintain a library of decode information, wherein the library of decode information comprises a reusable set of entries, each of the set of entries is to correspond to a respective one of a plurality of functions, and each entry is to include information to be used by an interconnect fabric to decode a transaction to involve the corresponding function; and
an interface to provide entries from the library of decode information to a hardware design tool.

18. The apparatus of claim 17, wherein each entry in the set is to describe:
a type of a corresponding base address register (BAR);
size of the corresponding BAR; and
attributes of supported transactions corresponding to the respective function.

19. A system comprising:
at least one processor device;
a decode information library, maintained in one or more memory elements, wherein the library of decode information comprises a reusable set of decode information entries, each of the set of entries is to correspond to a respective one of a plurality of functions, and each entry is to include decode information to be used by an interconnect fabric to decode a transaction corresponding to the respective function; and
a hardware design tool to consume one or more entries of the decode information library to generate a hardware description language object to represent an interconnect fabric to interconnect a set of computing blocks.

20. The system of claim 20, wherein the hardware design tool is to generate a respective HDL object for each of a plurality of fabrics, wherein the plurality of fabrics comprises a first fabric to interconnect a first set of computing blocks and a second different fabric to interconnect a second, different set of computing blocks.
